(19) United States
(12) Patent Application Publication
(10) Pub. No.: US 2007/0136492 A1
(43) Pub. Date: Jun. 14, 2007

(54) Method and system for compressing/decompressing data for communication with wireless devices

(75) Inventors: Adam Blum, Los Gatos, CA (US); Cliff Draper, Emerald Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Good Technology, Inc.

(21) Appl. No.: 11/297,974

(22) Filed: Dec. 8, 2005

(51) Int. Cl. G06F 15/16

(52) U.S. Cl. 709/247

(57) ABSTRACT

A system is disclosed. The system includes a server in communication with a device over a network. The server having a compressor/decompressor to identify a Simple Object Access Protocol (SOAP) message via web services description. The compressor/decompressor at server is further to compress the SOAP message according to the web services description such that the compressed SOAP message is capable of being transmitted to the device. The server having a data synchronizer to transmit the compressed SOAP message to the device.

### FIELD

This invention relates generally to the field of networks data services. More particularly, the invention relates to a method and system for compressing and decompressing data for communication with wireless devices.

### BACKGROUND

A variety of wireless data processing devices have been introduced over the past several years. These include wireless personal digital assistants (“PDAs”) such as the Treo 650 handheld, cellular phones equipped with data processing capabilities (e.g., those which include wireless application protocol (“WAP”) support), and, more recently, wireless messaging devices.

With the rise in the use of wireless devices, transmission of data to and from wireless devices is becoming increasingly important, and yet it is cumbersome. For example, wireless/mobile devices are known for having low bandwidth, high latency, slow processors, small memory, and small screens. None of the conventional ways for compressing/uncompressing data for transmission to and from wireless devices were designed considering such limitations of mobile devices. Consequently, transmission of highly compressed data to and from wireless devices is necessary. The problem is further exasperated when using Extensible Markup Language (XML)-based protocols. For example, XML parsing can be done with relative ease on bigger systems, such as desktops, but works poorly with wireless/mobile devices, given the limitations of such devices, when using conventional ways of compression/decompression.

### SUMMARY

In one embodiment, a system is disclosed for maintaining current data for wireless devices. The system includes a server in communication with a device over a network. The server having a compressor/decompressor (codec) to identify a Simple Object Access Protocol (SOAP) message via web services description. The codec at server is further to compress the SOAP message according to the web services description such that the compressed SOAP message is capable of being transmitted to the device. The server having a data synchronizer to transmit the compressed SOAP message to the device. The server is further to decompress the compressed SOAP message.

In another embodiment, a method is disclosed. The method includes identifying a SOAP message via web services description. The method further includes compressing the SOAP message according to the web services description such that the compressed SOAP message is capable of being transmitted to the device. The compressed message is then transmitted to the device. The method further includes decompressing the compressed SOAP message.

### BRIEF DESCRIPTION OF THE DRAWINGS

A better understanding of the present invention can be obtained from the following detailed description in conjunction with the following drawings, in which:

FIG. 1 illustrates an embodiment of a network to implement elements of the present invention;

FIG. 2 illustrates an embodiment of an architecture for compressing and decompressing data being transmitted between sever and device;

FIG. 3 illustrates an embodiment of a context of Simple Object Access Protocol components within server;

FIG. 4 illustrates an embodiment of a process for compressing and decompression of data using Web Services Definition Language and Simple Object Access Protocol compression/decompression dictionary;

FIG. 5 illustrates an embodiment of a process for dictionary generation;

FIG. 6 illustrates an embodiment of a process for performing finite state machine-based compression of data;

FIG. 7 illustrates an embodiment of a process for performing finite state machine-based decompression of data; and

FIG. 8 illustrates a computer system on which device and or server may be implemented.

### DETAILED DESCRIPTION

According to one embodiment a mechanism for compressing and decompressing data for communication with wireless devices. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

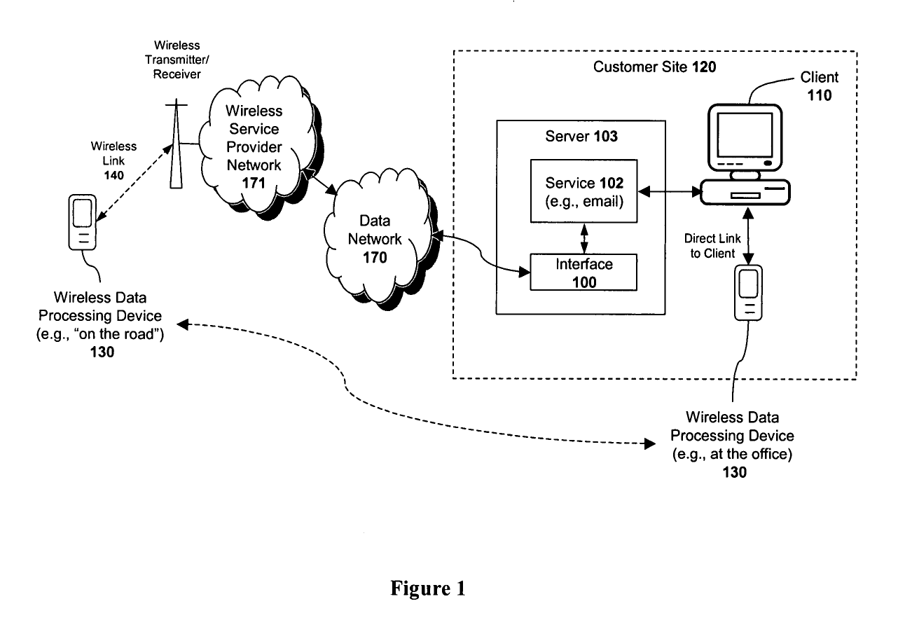

FIG. 1 illustrates one embodiment of a network architecture. A “customer site” 120 is illustrated in FIG. 1 and may be any local-area or wide-area network over which a plurality of servers 103 and clients 110 communicate. For example, customer site 120 may include all servers and clients maintained by a single corporation.

Servers 103 may provide a variety of different messaging and groupware services 102 to network users (e.g., e-mail, instant messaging, calendaring, etc). However, the underlying principles of the invention are not limited to any particular messaging/groupware platform.

In one embodiment, an interface 100 forwards data objects (e.g., e-mail messages, instant messages, calendar data, etc.) maintained by service 102 to a plurality of wireless data processing devices (represented in FIG. 1 by device 130) via an external data network 170 and/or a wireless service provider network 171. For example, server 103 serves as a proxy for the web service that delivers data on a wireless network to various mobile devices 130.

In one embodiment, interface 100 is a software module adapted to work with the particular service 102. It should be noted, however, that interface 100 may be implemented in hardware or any combination of hardware and software while still complying with the underlying principles of the invention.

In one embodiment, the external data network 170 includes a plurality of databases, servers/clients (not shown) and other networking hardware (e.g., routers, hubs, etc) for transmitting data between the interface 100 and the devices 130. In one embodiment, the interface 100 encapsulates data in one or more packets having an address identifying the devices 130 (e.g., such as a 32-bit Mobitex Access Number (“MAN #”)).

The external data network 170 transmits the packets to a wireless service provider network 171, which in turn, transmits the packets (or the data contained therein) over a wireless communication link to the device 130. In one embodiment, the wireless service provider network is a CDMA 2000 network. However, various other network types may be employed (e.g., Mobitex, GPRS, PCS, etc.) while still complying with the underlying principles of the invention.

It should be noted that the network service provider network 171 and the external data network 170 (and associated interface 100) may be owned/operated by the same organization or, alternatively, the owner/operator of the external data network 170 may lease wireless services from the wireless service provider network. The underlying principles of the invention are not limited to any particular service arrangement.

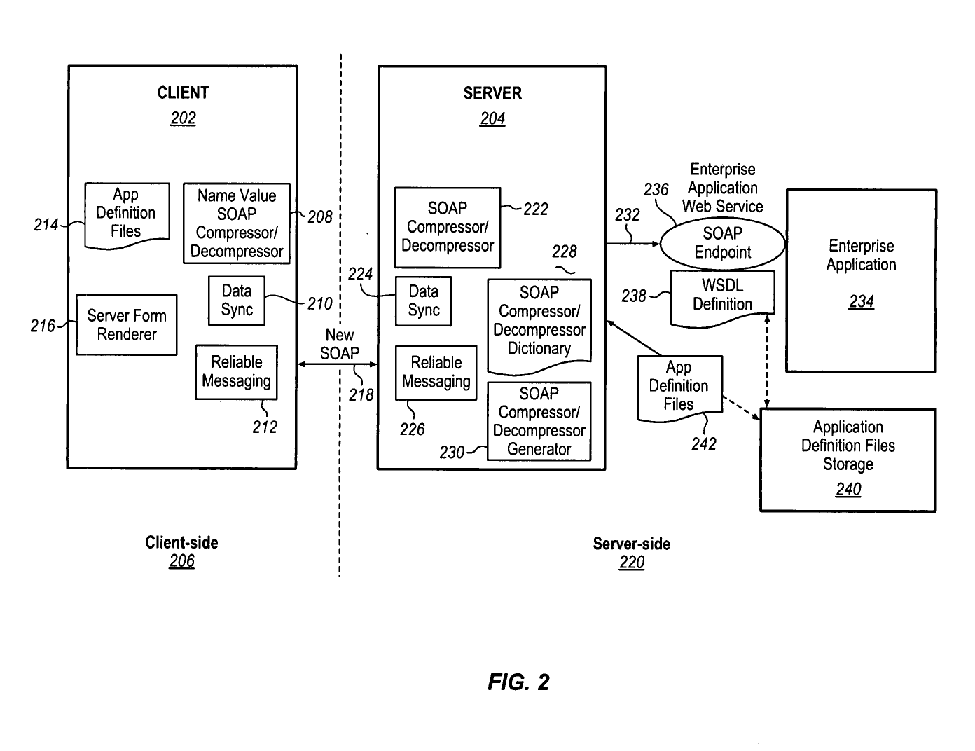

FIG. 2 illustrates an embodiment of an architecture for compressing and decompressing data being transmitted between sever 204 and device 202. In the illustrated embodiment, a client-side 206 and an enterprise-side 220. The client-side 206 includes a wireless processing client or device (device) 202 that is coupled to and in communication with server 204. Device 202 includes any device having a mobile computer systems or devices, such as a laptop computer, a mobile telephone (e.g., mobile cellular phones, smartphones, etc.), a personal digital assistant (PDA), a pocket computer, etc. Server 204 is further in communication with a web services enterprise server (enterprise server) which provides web services and web services-based enterprise applications 234. It is contemplated that server 204 and enterprise server 220 are in communication with each other via a network. Device 202 and server 204 are in communication with backend enterprise server via exposed web services and web services application 234. Examples of the network may include a local area network (LAN), a wide area network (WAN), a metropolitan area network (MAN), an internet, the Intranet, and the like. Further, the network is coupled to and in communication with a wireless network. Server 204 may include GoodLink™ server, Good Access Web Services (GAWS) server, etc., provided by Good Technology, Inc. of Santa Clara, Calif. Examples of web services enterprise server include Web Application Server developed by SAP AG of Walldorf, Germany, and WebSphere Application Server developed by International Business Machines Corp. (IBM®) of Armonk, N.Y.

In one embodiment, communication of data between device 202 and server 204 is performed via new SOAP 218. New SOAP 218 represents data that is compressed for transmission of data to and from mobile devices 202. New SOAP 218 may also include compressed XML. Such compression of data is performed using SOAP compressor/decompressor 222 at server 204 which uses Web Services Definition Language (WSDL) 238. WSDL 238 is used to obtain relevant information about data as WSDL 238 is a metadata file that describes what each possible SOAP message would appear like when using standard XML. In other words, having WSDL 238 means various operations provided by web services and how to use them are known. In one embodiment, a SOAP encoder at SOAP codec 222 may take a SOAP message and some information from WSDL 238 and produce a stream of bytes intended to be sent over the air to device 202 via new SOAP 218 using server data synchronizer (server data sync) 224 and device data synchronizer (device data sync) 210 and server and device reliable messagings 226, 212. A SOAP decoder or decompressor at SOAP codec 222 may then take that byte stream and some information from WSDL 238 to reproduce the original SOAP message 232.

In one embodiment, server 204 includes SOAP codec 222, server data sync 224, new SOAP compression or SOAP codec dictionary (dictionary) 228, new SOAP compression generator or SOAP codec dictionary generator (dictionary generator) 230, and server reliable messaging 218. Server 204 is in coupled with application definition files (ADF) storage 240 to communicate ADFs 242. Client 202 includes ADF 214 communicated via server 204, server form renderer 216, device data sync 210, and device reliable messaging 212. SOAP 232 allows server 204 and enterprise application 234 (via web services and web services enterprise server) to support a common data transfer protocol for effective networked communication. Client 202 also includes name value-SOAP codec 208 in communication with SOAP codec 222 at server 204. Server 204 and enterprise server are senders and receivers of XML documents.

SOAP refers to a standard, XML-based protocol which serves as an XML application programming interface (API). XML is regarded as highly regular, readable by humans, flexible, and verbose. SOAP often uses the HyperText Transport Protocol (HTTP) to facilitate XML messaging. For example, instead of using HTTP to request a HyperText Messaging Language (HTML) page to be downloaded and displayed in a browser, SOAP sends an XML message via HTTP request and receives a reply, if any, via HTTP response. Typically, SOAP interactions occur between SOAP nodes, which can be SOAP message senders, receivers, or both. Further, SOAP messages include three major blocks, such as envelope, header, and body. Envelope is referred to as a unit of communication. Header includes attributes or qualities of the communication, while body includes the message having message names with arguments or documents.

In the illustrated embodiment, SOAP 232 is used via SOAP codec 222 at server 204 and SOAP endpoint 236 at enterprise application web services. New SOAP 218 is transmitted between device reliable messaging 212 and server reliable messaging 226 at device 202 and server 204, respectively. WSDL 238 provides a metadata file that describes what SOAP messages 218, 232 look like when using standard XML. It is contemplated that WSDL 238 also contains other metadata. Using the metadata at WSDL 238, various operations as provided by web services are known and also known are how to use them.

A SOAP encoder or compressor at codec 222 receives a SOAP message 232 and SOAP codec dictionary 228 (e.g., via some boiled down information from WSDL (e.g., WSDL definition 238)) to produce a stream of bytes intended to be sent over the air. The stream of bytes is then sent to device 202 as new SOAP 218 to device reliable messaging 212 via data sync 224 and server reliable messaging 226 at server 204. In one embodiment, SOAP codec 222 is helped by dictionary 228, which is created by dictionary generator 230 at server 204 using WSDL 238. Dictionary 228 specifies the expected elements in the XML message, their data types, and other helpful information. Dictionary 228 merely changes when the content in WSDL 238 changes which is infrequent. Dictionaries 228 are sent once in separate cover from compressed messages. The same dictionary 228 that was used to compress the message is then used to uncompress or decompress it later. In one embodiment, compression is performed using finite state machine (FSM) SOAP method, which yields high compression ratios. In another embodiment, compression is performed using a packed SOAP method, which also yields high compression ratios as well as easily handles any unexpected data.

In one embodiment, using packed SOAP method, encoding of elements and attributes is performed. Using WSDL, we can determine what element names are going to be in the messages. In the codec 222, such element names are gathered up and given an estimated frequency. For example, knowing that the “Customers” element is going to appear once, while the “Customer” element is a repeating element, “Customers” has a frequency of 1 and “Customer” is assigned a frequency of AVERAGE_ARRAY_SIZE (e.g., 8). Customer's children (e.g., “Name”) inherit their parent's frequency, so “Name” also has a frequency of AVERAGE_ARRAY_SIZE. If an element is optional, then just half the value of what is required is added. A statistical expected value may be calculated based on minimum and maximum occurrence values.

Since while decoding, SOAP codec 222 can remember what the next end element would be, ending elements are consolidated into a single END_ELEMENT token. A few other special tokens are added for unexpected XML, such as UNKNOWN_ELEMENT and UNKNOWN_ATTRIBUTE. This is so that when an element is encountered in the original XML which is not in the table, then an UNKNOWN_ELEMENT is emitted with enough information to reconstruct the XML when decoding. Although the compression ratio may suffer a bit when unknown elements or attributes are encountered, the data is preserved. The frequency is calculated across various messages and operations contained in WSDL 238. A Huffman bit code may then be calculated and assigned. This way, the tokens that are likely to be most used occupy the least number of bits. Huffman bit code is part of the Huffman encoding representing algorithm for the lossless compression of files based on the frequency of occurrence of a symbol in the file that is being compressed.

Further, two additional tokens are also added, such as DEFINE_NAMESPACE and CHANGE_DEFAULT_NAMESPACE. These tokens are used whenever the XML defines a namespace (e.g., xmlns:prefix=‘urn:ws’), or changes the default namespace (e.g., xmlns=‘urn:foo’). Since they also occur infrequently, they are given a frequency of 0. Additionally, a SOAP fault could come back from server 204 even if not specified in WSDL 238. Thus, one or more of the following elements are also added with a low frequency (0.1): soap:Fault, faultcode, faultstring, and detail. These are standard elements in a SOAP fault.

With regard to data content encoding, one of the properties of the XML Schema in WSDL 238 allows the type of data associated with an element to be known. For example, it is known that “Name” is a string, “Age” is a 32-bit integer, “Alive” is a Boolean, “Customer” is an element container, etc. By knowing the type, different methods can be used to compress different data. For instance, since a Boolean takes up a single bit where 0 represents false, 1 represents true, eight Booleans next to each other would take up a single 8-bit byte, whereas the original data takes up from 32 to 40 bytes (from “true”.length * 8 to “false”.length * 8). Further, encoding for one or more of the following is also provided: (1) xsd:boolean; (2) non-negative integer types; (3) signed integer types (e.g., xsd:int, xsd:long, xsd:short, etc.); (4) xsd:float and xsd:double; (5) xsd:byte; (6) xsd:base64Binary; (7) xsd:hexBinary; (8) xsd:date; (9) xsd:time; (10) xsd:dateTime; (11) xsd:duration; xsd:string or anything not otherwise specified; and (12) xsd:QName.

Moreover, XML schema can specify that the data content of an element is from an enumeration. For instance, an element named “color” may have only 3 possible values: red, green, or blue. Instead of emitting the data content of the color element as a length prefix and a 3, 4, or 5 byte string, merely 2 bits need to be used, such as 00 for red, 01 for green, 10 for blue. These bit codes are stored at dictionary 228. Just in case a value is used that is outside of the enumeration, a bit code is stored for an unexpected value. So, if yellow is found, an 11 is emitted followed by the usual encoding for that type. The actual bit codes may be calculated using the Huffman encoding where simply the unexpected value has a lower Huffman frequency.

Some XML data has repeating strings. The application definition (e.g., an AAC file) is a good example of such. The compressor can be used to build a string table of the data of type string in the XML. Again, frequencies are counted and the Huffman encoding is calculated. For example, the string “Account” may be assigned a few bits (like 0101) and the string “Xyzzy” may be assigned several bits. The string table is emitted in the first part of the output stream. Then, whenever a string is encountered, merely the bit code is used. XML Schema can also have additional metadata on types providing additional information about the formatting or the values; these are known as facets. For example, one can specify for an integer a minimum value of 1000 and a maximum value of 1015. In general, the closer a value is to 0, the fewer number of bits it takes up. So, minimum values are subtracted, moving the range from 0 to 15, merely needing 4 bits to represent.

In one embodiment, when using FSM SOAP method, FSM encoding is used for compression and decompression of data transmitted to and from device 202. Using WSDL 238 in light of FSM encoding, a significant pattern to input data can be observed and known. For example, the pattern not only provides types of the content data, but also provides structure of the data, such as how the elements are arranged, etc. For example, first comes SOAP envelope, then SOAP body, and then either QueryForCustomers or Example element. If QueryForCustomers is determined, Names with elements follow. For Example element, Customers element follows. It is when making choices that encoding of any information in the compressed output stream is performed.

In one embodiment, various elements of the input data as determined from the structural pattern of the data are then plotted into a SOAP message to form FSM. An automata goes from state to state (e.g., circle to circle of FSM graph) via transitions (arrows). FSM graph is then stored in an FSM dictionary at dictionary 228 along with the data type information. SOAP Header and SOAP Fault are automatically added, since they can be part of the message without WSDL 238 instructing as such. When the encoder at SOAP codec 222 encounters SOAP Envelope, it emits nothing to the output stream since that was expected. When the encoder encounters SOAP body, it emits the 1 bit. If Example element is next, a 0 bit is emitted. From the Example element, a Customers element is encountered next. Since there was no choice, no bits are emitted. From the Customers element, a Customer element is hit next, also no bits are emitted since it was expected. From Customers, it goes to Name emitting no bits. At this point, Name is a type string, so the string content is emitted. The same rules for emitting content data hold as for the packed codec at SOAP codec 222 when using packed SOAP method.

In FSM graph, the Alive and Child elements may be optional. So, for example, after Age, the choice may be to go to any one of Alive, Child, and Customer end element. Also, there may be loops. Child element may repeat, so there are 2 choices: to hit another Child element or to hit Customer end element. Similarly, from Customer end element, another Customer element or Customers end element may be hit. When there's a choice between 2 things, one side may be assigned a 0 and the other side may be assigned a 1. The assigning of the bit codes may be done using the Huffman encoding. Then, the frequency is computed with one or more of the following parameters: optional elements having less weight (since they're less likely to be there), repeating elements having more weight (since their expected value is higher, i.e., when known that an element can appear from 0 to 5 times. In this case, on average, it is seen 3 times. Also, distance away, the next element to be hit is more likely to be the one that is next in the definition).

In one embodiment, the compression is high as most of the structural data in the XML is no longer needed. However, FSM codec at SOAP codec 222 may not handle unexpected elements as there may not be room for adding transitions to unexpected elements. In this case, in one embodiment, if an unexpected element is discovered, FSM codec may give up and allow packed codec at SOAP codec 222 to handle the unexpected elements.

In one embodiment, FSM is generated by following each path in the XML schema. In many cases, multiple and completely different paths contain shared structures. For example, in a sales web service, there may be an Account business object that is represented in the XML Schema as an Account element with subelements for account id, name, primary contact, address, URL, phone number, etc. That Account object may be sizable. The web service may have multiple operations that deal with that Account object. Examples of such multiple operations include updateAccount, createAccount, queryForAllAccounts, and queryForAccountsByName, etc. Continuing with the sales web service example, if the Account object has m states and it is used n times across WSDL 238, then that is regarded as m*n number of states taken up by this single Account type, which occupies a large amount of space in the dictionary. Out of this comes a subFSM, which is regarded as a subroutine. A subFSM is an FSM in its own right, but it is called from a parent FSM. So, the Account type takes up n states and is referenced m times. Not every type in the schema is pulled out into a subFSM. Simply those types that are referenced more than once and their m*n (number of states they would have taken up) exceeds a predefined threshold.

Using a pre-computed FSM dictionary at dictionary 228 is different from conventional text based compression algorithms, such as LZW, which can be found in gzip. LZW merely looks for a pattern of bytes within a sliding window of bytes (e.g., 32 k). In one embodiment, SOAP FSM leverages knowing the structural and content patterns from WSDL 238 by generating FSM and storing it in a dictionary 228 to be used for both compression and decompression.

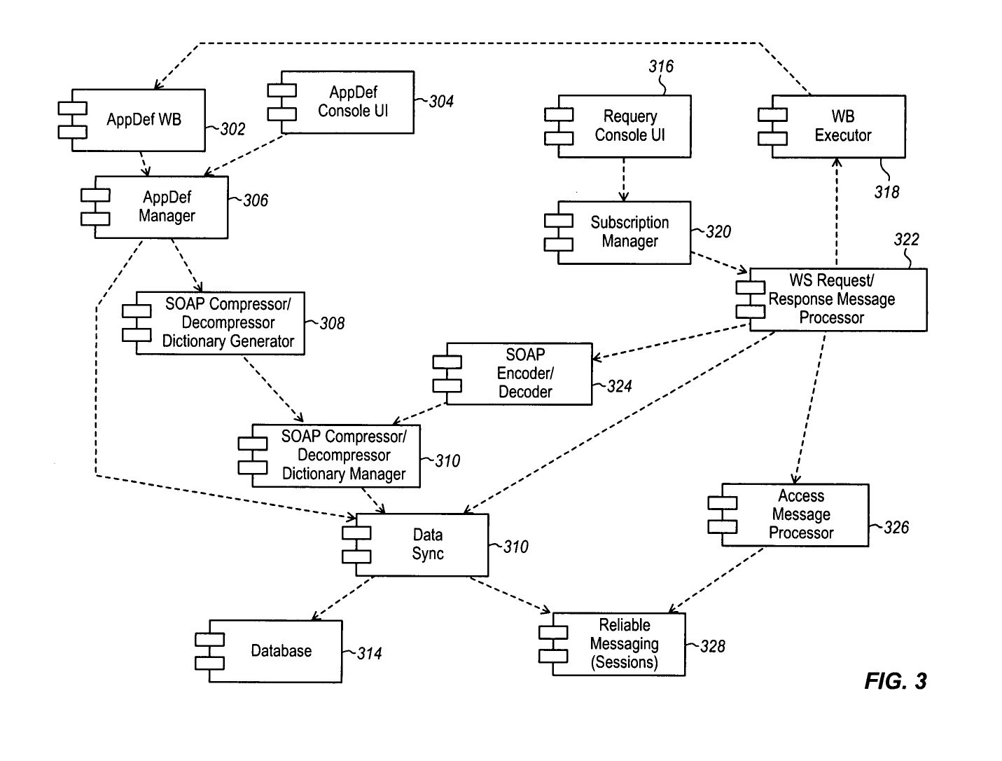

FIG. 3 illustrates an embodiment of a context of SOAP components 302-328 within server 204. Deployment time components include application definition (AppDef) Webswell Broker (WB) (AppDef WB) 302, AppDef console user interface (AppDef console UI) 304, AppDef manager 306, and SOAP codec dictionary generator 308. Runtime components include requery console UI 316, web services (WS) executor 318, subscription manager 320, WS request/response message processor 322, SOAP encoder/decoder or compressor/decompressor 324, access message processor 326, and reliable messaging (session) 328. Other components that are both deployment time and runtime components include SOAP codec dictionary manager 310, data sync 312, and database 314.

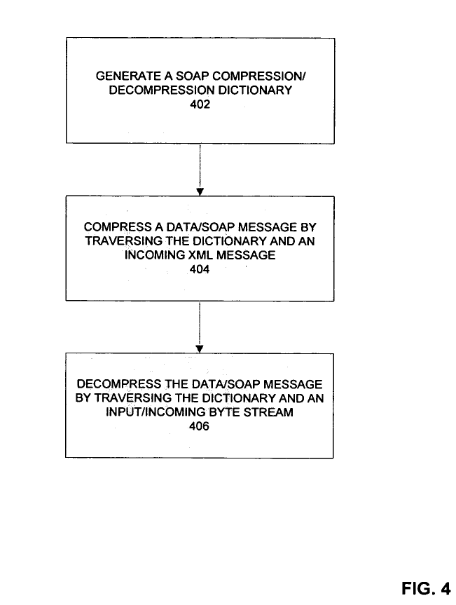

FIG. 4 illustrates an embodiment of a process for compressing and decompression of data using Web Services Definition Language and Simple Object Access Protocol compression/decompression dictionary. At processing block 402, a SOAP codec dictionary is generated from WSDL. In one embodiment, to compress data or SOAP message, the newly generated dictionary and an in-coming XML message are traversed at processing block 404. As a result, an output byte stream is then generated at processing block 404. The dictionary may then be reused for each XML message from the web service as described by WSDL. In one embodiment, at processing block 406, to uncompress or decompress data or SOAP message, the dictionary and an input or in-coming byte stream are traversed. As a result, an output XML message is then generated.

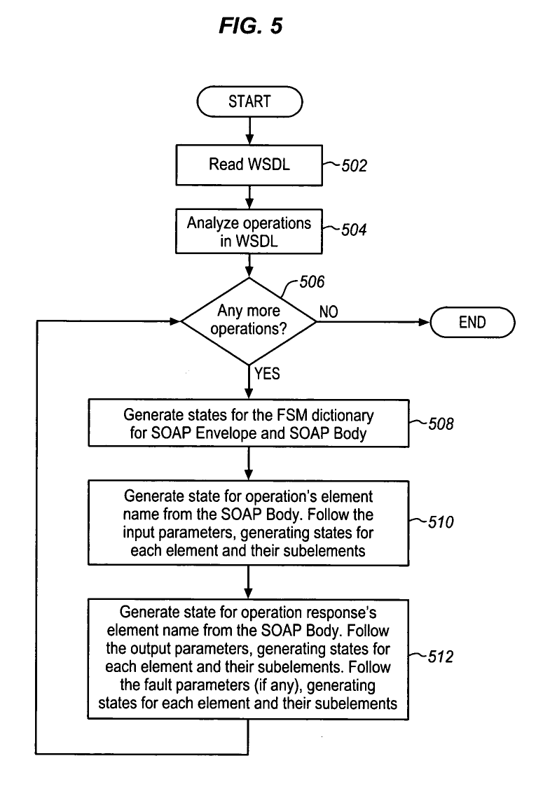

FIG. 5 illustrates an embodiment of a process for dictionary generation. At processing block 502, WSDL is read. In one embodiment, operations in WSDL are then analyzed at processing block 504. At decision block 506, a determination is made as to if there are additional operations in WSDL. If there are no more operations, the process ends at termination block 514. If there are additional operations, states for FSM dictionary are generated for SOAP envelope and SOAP body at processing block 508.

In one embodiment, state for an operation's element name for the SOAP body is generated at processing block 510. Further, input parameters are followed and then, a state for each of the elements and their sub-elements is generated. At processing block 512, state for operation response's element name from the SOAP body is generated. Then, output parameters are followed, and a state for each of the elements and their sub-elements is generated. Fault parameters, if any, are then followed, and states for each of the elements and their sub-elements are generated. At decision block 506, a determination is made as to whether there are any more operations. If yes, the process continues with processing block 508. If not, the process ends with termination block 514.

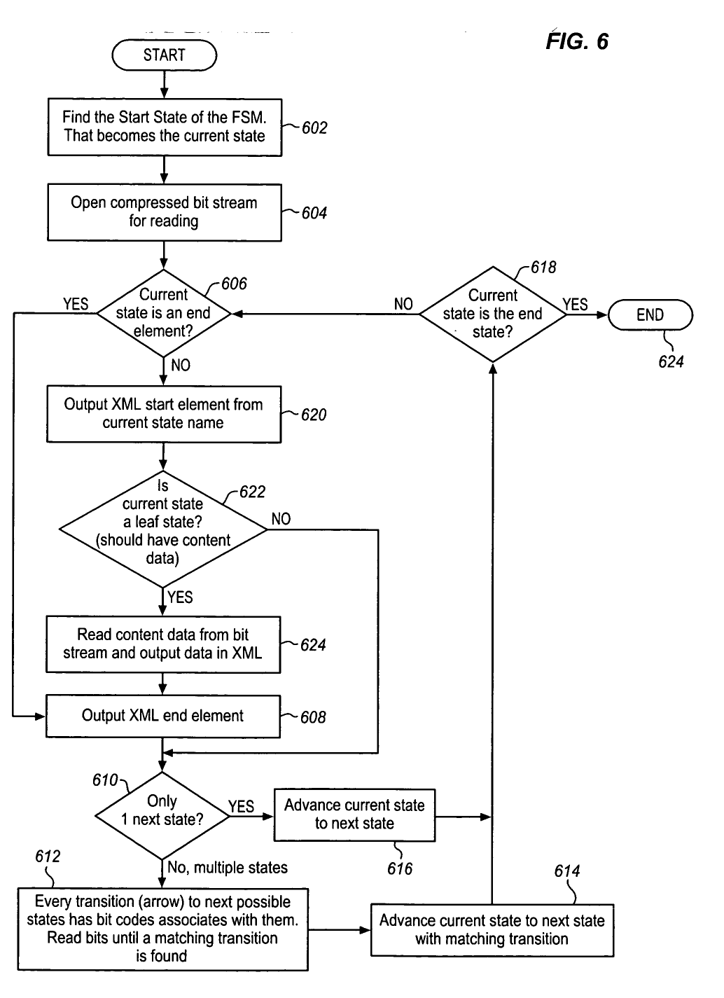

FIG. 6 illustrates an embodiment of a process for performing finite state machine-based compression of data. In one embodiment, the start state of the previously generated FSM (as described with references to FIGS. 4 and 5) is determined at processing block 602. The start state is regarded as the current state. At processing block 604, a compressed bit stream is opened for reading.

At decision block 606, a determination is made as to whether the current state is an end element. In one embodiment, the current state is an end element, the process continues with the output of XML end element at processing block 608. At decision block 610, another determination is made as to whether there is only one next step. If there is only one next step, the current step is advanced to the next state at processing block 616. If the current state is the end state as determined at decision block 618, the process ends at termination block 624. If the current state is not the end state, the process continues with decision block 606 to determine whether the current state is an end element.

Referring back to decision block 610, if there are multiple next states, each transition to next possible states have bit codes associated with them at processing block 612. These bits are read until a matching transition is discovered. The current state is then advanced to the next state with matching transition at processing block 614. If the current state is the end state at decision block 618, the processing ends at transition block 624. Otherwise, the process continues with decision block 606.

Referring back to decision block 606, in one embodiment, if the current state is not an end element, the process continues with the output of XML start element from current state name at processing block 620. If the current state is a leaf state (e.g., has content data) at decision block 622, the process continues with reading of the content data from bit steam and output data in XML at processing block 624. The process continues with the output of XML end element at processing block 608. On the other hand, if the current state is not a leaf state, the process continues with decision block 610 with whether there is only one next state.

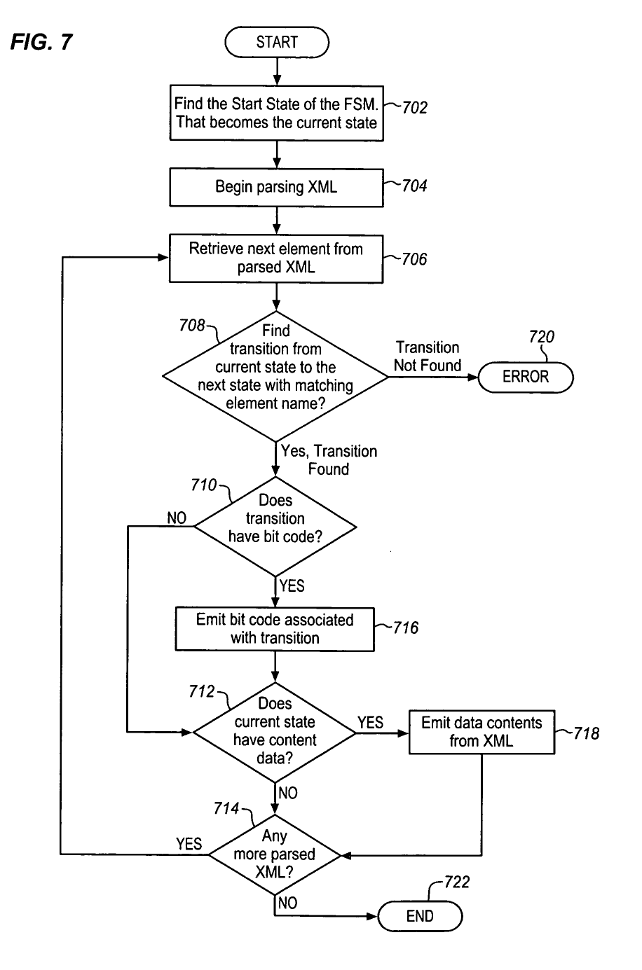

FIG. 7 illustrates an embodiment of a process for performing finite state machine-based decompression of data. For performing FSM-based decompression or uncompression of data, the start state of the FSM is determined at processing block 702. At processing block 704, XML is parsed. At processing block 706, the next element is retrieved from the parsed XML. Then, transition from the current state to the next state with matching element name is determined at decision block 708. If no such transition is found, the process ends (e.g., an error is thrown) at termination block 720. If such transition is found, whether that transition has a bit code is determined at decision block 710.

If a bit code associated with the transition is found, the bit code is then emitted at processing block 716. If no such bit code is found or once the bit code is emitted, the process continues with the determination of whether the current state has content data at decision block 712. If there is content data, such content data is emitted from XML at processing block 718. If no such content is found or once the content data is emitted from XML, the process continues with whether more XML is to be parsed at decision block 714. If there is not more XML to be parsed, the process ends at termination block 722. If there is more XML to be parsed, the process continues with retrieving of the net element from the parsed XML at processing block 706.

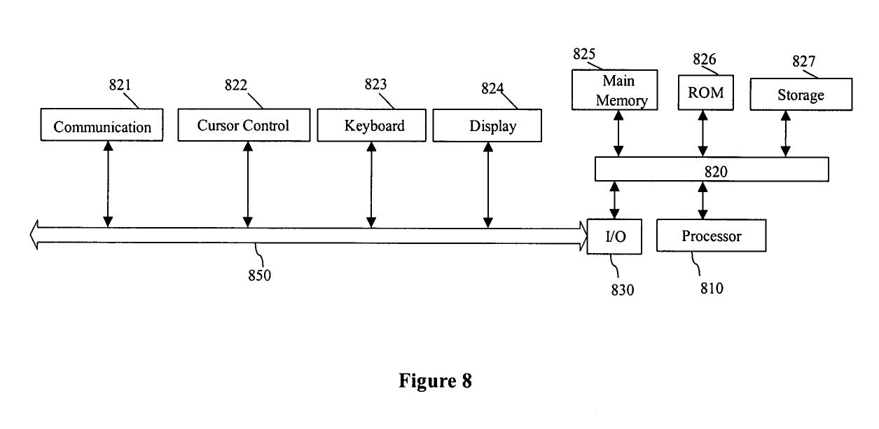

FIG. 8 illustrates a computer system 800 on which device 130 and or server 103 may be implemented. Computer system 800 includes a system bus 820 for communicating information, and a processor 810 coupled to bus 820 for processing information. According to one embodiment, processor 810 is implemented using one of the multitudes of Motorola ARM family of processors of microprocessors. Nevertheless one of ordinary skill in the art will appreciate that other processors may be used.

Computer system 800 further comprises a random access memory (RAM) or other dynamic storage device 825 (referred to herein as main memory), coupled to bus 820 for storing information and instructions to be executed by processor 810. Main memory 825 also may be used for storing temporary variables or other intermediate information during execution of instructions by processor 810. Computer system 800 also may include a read only memory (ROM) and/or other static storage device 826 coupled to bus 820 for storing static information and instructions used by processor 810.

A data storage device 825 such as a magnetic disk or optical disc and its corresponding drive may also be coupled to computer system 800 for storing information and instructions. Computer system 800 can also be coupled to a second I/O bus 850 via an I/O interface 830. A plurality of I/O devices may be coupled to I/O bus 850, including a display device 824; an input device (e.g., an alphanumeric input device 823 and/or a cursor control device 822).

The communication device 821 is for accessing other computers (servers or clients) via network 170. The communication device 821 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, while illustrated as an interface 100 to a service 102 executed on a server 103 (see FIG. 1); it will be appreciated that the underlying principles of the invention may be implemented on a single client in which the client transmits data over a network. Accordingly, the scope and spirit of the invention should be judged in terms of the claims which follow.

What is claimed is:

1. A system, comprising:
a device to communicate data with a server; and
the server in communication with the device over a network, the server having
a compressor/decompressor to identify a Simple Object Access Protocol (SOAP) message via web services description, and compress the SOAP message in accordance with the web services description such that the compressed SOAP message is capable of being transmitted to the device, and
a data synchronizer to transmit the compressed SOAP message to the device.

2. The system of claim 1, wherein the web services description is provided by Web Services Definition Language (WSDL), the WSDL comprising a metadata file having the web services description, the web services description including descriptive information relating to the data, the descriptive information including information relating to web services operations.

3. The system of claim 1, wherein the compressor/decompressor is further to identify the SOAP message via one or more application definition files.

4. The system of claim 1, wherein the compressed SOAP message comprises a byte stream being transmitted wirelessly to the device.

5. The system of claim 1, wherein the server further comprises a dictionary generator to generate a dictionary via the WSDL.

6. The system of claim 5, wherein the compressor/decompressor is further to compress the SOAP message by traversing the dictionary and an incoming XML message to generate an outgoing byte stream.

7. The system of claim 5, wherein the compressor/decompressor is further to decompress the SOAP message by traversing the dictionary and an incoming byte stream to generate an outgoing XML message.

8. The system of claim 1, wherein the WSDL resides at a web services server, the web services server coupled with the server over a network.

9. The system of claim 1, wherein the web services description further comprises information pertaining to identification of the SOAP message.

10. A method, comprising:
identifying a SOAP message via web services description;
compressing the SOAP message in accordance with the web services description such that the compressed SOAP message is capable of being transmitted from a server to a device; and
transmitting the compressed the SOAP message to the device.

11. The method of claim 10, wherein the web services description is provided by WSDL, the WSDL comprising a metadata file having the web services description, the web services description including descriptive information relating to the data, the descriptive information including information relating to web services operations.

12. The method of claim 10, wherein the identification of the SOAP message further comprises identifying the SOAP message via one or more application definition files.

13. The method of claim 10, further comprising generating a dictionary via the WSDL.

14. The method of claim 13, further comprising compressing the SOAP message by traversing the dictionary and an incoming XML message to generate an outgoing byte stream.

15. The method of claim 13, decompressing the SOAP message by traversing the dictionary and an incoming byte stream to generate an outgoing XML message.

16. A machine readable medium having stored thereon data representing sets of instructions which, when executed by a machine, cause the machine to:
identify a SOAP message via web services description;
compress the SOAP message in accordance with the web services description such that the compressed SOAP message is capable of being transmitted from a server to a device; and
transmit the compressed the SOAP message to the device.

17. The machine-readable medium of claim 16, wherein the web services description is provided by WSDL, the WSDL comprising a metadata file having the web services description, the web services description including descriptive information relating to the data, the descriptive information including information relating to web services operations.

18. The machine-readable medium of claim 16, wherein the sets of instructions which, when executed by the machine, further cause the machine to generate a dictionary via the WSDL.

19. The machine-readable medium of claim 18, wherein the sets of instructions which, when executed by the machine, further cause the machine to compress the SOAP message by traversing the dictionary and an incoming XML message to generate an outgoing byte stream.

20. The machine-readable medium of claim 18, wherein the sets of instructions which, when executed by the machine, further cause the machine to decompress the SOAP message by traversing the dictionary and an incoming byte stream to generate an outgoing XML message.
